(19) United States
(12) Patent Application Publication
(10) Pub. No.: US 2025/0264278 A1
(43) Pub. Date: Aug. 21, 2025

(54) NOVEL FURNACE DOOR HEATING APPARATUS AND HORIZONTAL SINTERING FURNACE THEREOF

(71) Applicants: Hunan Linxin New Materials Co., Ltd., Changsha (CN); Zhuzhou Ruideer Intelligent Equipment Co., Ltd., Zhuzhou (CN)

(72) Inventors: Junguang XIAO, Zhuzhou (CN); Ping TAN, Zhuzhou (CN); Simin ZOU, Zhuzhou (CN); Yingxin LI, Zhuzhou (CN)

(73) Assignees: Hunan Linxin New Materials Co., Ltd., Changsha (CN); Zhuzhou Ruideer Intelligent Equipment Co., Ltd., Zhuzhou (CN)

(21) Appl. No.: 18/685,814

(22) PCT Filed: Sep. 1, 2021
(86) PCT No.: PCT/CN2021/115962

§ 371 Date: Feb. 22, 2024

(30) Foreign Application Priority Data
Aug. 23, 2021 (CN) 202110971918.0

(51) Int. Cl. F27D 1/18; F27B 21/00; F27D 11/10

(52) U.S. Cl. CPC F27D 1/18; F27B 21/00; F27D 11/10

(57) ABSTRACT

A novel furnace door heating apparatus and a horizontal sintering furnace thereof are provided. The novel furnace door heating apparatus includes: a main heating body, the main heating body includes a first main heating body, a second main heating body, and a third main heating body, the first main heating body and the second main heating body are arranged opposite to each other in the X-axis direction, and the third main heating body is arranged at a bottom position of the first main heating body and the second main heating body in the Z-axis direction; and auxiliary heating bodies, the auxiliary heating bodies are arranged in two end regions of the main heating body in the Y-axis direction, and both are arranged adjacent to the main heating body. The two end regions of the main heating body in the Y-axis direction are provided with the auxiliary heating bodies.

### CROSS REFERENCE TO RELATED APPLICATION

This application is a national stage application of International Patent Application No. PCT/CN2021/115962, filed on Sep. 1, 2021, which claims the priority of Chinese Patent Application No. 202110971918.0 entitled “NOVEL FURNACE DOOR HEATING DEVICE AND HORIZONTAL SINTERING FURNACE THEREOF” filed with the Chinese Patent Office on Aug. 23, 2021, which is incorporated herein by reference in its entirety.

### TECHNICAL FIELD

The present disclosure relates to the technical field of sintering furnace products, in particular to a novel furnace door heating apparatus, and a horizontal sintering furnace thereof.

### BACKGROUND

The sintering furnace is a special device that sinters powder compact to obtain the required physical, mechanical properties and microstructure, and may usually be used to dry the slurry on the silicon wafer, remove the organic components in the slurry and complete the sintering of aluminum back surface field and grid lines. The sintering furnace, due to its advantages of large production, uniform product quality, high thermal efficiency, low cost of furnace building materials and heating elements, long service life, low peak power and capability of saving sintering cost, has been widely used in many modern industrial scenes.

However, the sintering furnace in the prior art has the following technical defects and deficiencies: there is a common phenomenon in the use of the horizontal sintering furnace, that is, there is a big difference between the temperature of two ends of the horizontal sintering furnace and the temperature of the middle portion of the horizontal sintering furnace, which has a great impact on the quality of the whole heat-treated product in the device; and the most important manifestation of temperature difference is that the temperature of the middle portion of the horizontal sintering furnace is higher than that of the two ends of the horizontal sintering furnace. Moreover, due to the structural design of the heating apparatus, it is impossible to adjust the heating value at the two ends of the horizontal sintering furnace in real time, and thus it is difficult to reduce the temperature difference of the product.

Therefore, there is an urgent need of a sintering furnace capable of solving the problem that local temperature at two ends of the heating apparatus is lower than that at a material bearing region in the prior art.

### SUMMARY

In order to overcome at least one defect in the prior art, the present disclosure provides a novel furnace door heating apparatus and a horizontal sintering furnace thereof, which have simple and reasonable structure design, small temperature difference the product region, high qualification rate of a product, and high quality.

The technical solution adopted by the present disclosure for solving the problem is as follows.

A novel furnace door heating apparatus includes:

a main heating body, where the main heating body comprises a first main heating body, a second main heating body, and a third main heating body, the first main heating body and the second main heating body are arranged opposite to each other in an X-axis direction, and the third main heating body is arranged at a bottom position of the first main heating body and the second main heating body in a Z-axis direction;

auxiliary heating bodies, where one of the auxiliary heating bodies is arranged in one of two end regions of the main heating body in a Y-axis direction, and an other one of the auxiliary heating bodies is arranged in an other one of two end regions of the main heating body in a Y-axis direction; and the auxiliary heating bodies are arranged adjacent to the main heating body.

A material bearing region is formed among the first main heating body, the second main heating body and the third main heating body, and the first main heating body, the second main heating body and the third main heating body are configured for heating the material bearing region.

The auxiliary heating bodies are independent temperature control devices, and are configured for heating the two end regions of the main heating body in the Y-axis direction.

Further, the main heating body may include first electric frames and multiple first heating elements, and the multiple first heating elements may be fixedly assembled between two first electric frames and may extend between the two first electric frames in the Y-axis direction.

Further, a number of the multiple first heating elements may be greater than or equal to two, and distances between every two adjacent first heating elements of the multiple first heating elements may be equal to make the multiple first heating elements uniformly distributed between the first electric frames.

Further, each of the first electric frames may be assembled with an electric frame connecting seat, the electric frame connecting seat may be provided with a first electrode connecting hole, and the first electrode connecting hole may be configured for connecting with a first electrode.

Further, each of the first electric frames may be of an arc structure, which may enable the main heating body as a whole to form a circular arc structure with a concave cavity, and concave cavities of the first main heating body, the second main heating body and the third heating body all may face the material bearing region.

Further, the novel furnace door heating apparatus further may include fixing nuts. The fixing nuts may penetrate through the first electric frames and then through the multiple first heating elements in the Y-axis direction to fixedly assemble the multiple first heating elements on the first electric frames.

Further, each of the auxiliary heating bodies may include second electric frames and a multiple second heating elements, and the multiple second heating elements may be fixedly assembled between two second electric frames and may extend between the two second electric frames in the X-axis direction.

Further, a number of the multiple second heating elements may be greater than or equal to two, and distances between every two adjacent second heating elements of the multiple second heating elements may be equal to make the multiple second heating elements uniformly distributed between the second electric frames.

Further, each of the second electric frames may be provided with a protruded portion, the protruded portion may be provided with a second electrode connecting hole, and the second electrode connecting hole may be configured for connecting a second electrode.

Based on the same design thought, the present disclose further provides a horizontal sintering furnace including the novel furnace door heating apparatus is further provided, which further includes a furnace door. The auxiliary heating bodies are fixedly assembled on the furnace door by means of electrodes, such that relative positions of the auxiliary heating bodies and the furnace door remain unchanged when the furnace door is opened or closed.

In conclusion, compared with the prior art, the novel furnace door heating apparatus and a horizontal sintering furnace thereof provided by the embodiments at least have the following technical effects.

(1) According to the novel furnace door heating apparatus and the horizontal sintering furnace thereof, two end regions of the main heating body in the Y-axis direction are provided with the auxiliary heating bodies, and the heat generated by the two newly increased auxiliary heating bodies can be directly radiated to low-temperature regions of the two end regions of the main heating body, thereby thoroughly solving the technical problem that the temperature of the two ends of a traditional heating apparatus is lower than that of the middle portion of the traditional heating apparatus, and ensuring the product consistency of the whole product.

(2) According to the novel furnace door heating apparatus and the horizontal sintering furnace thereof, the auxiliary heating body is an independent temperature control apparatus. When the main heating body adjusts the power, the heating value of the material bearing region will increase correspondingly as a whole, and the temperature of the two end regions of the main heating body cannot be adjusted independently, but the auxiliary heating bodies with independent temperature control function can adjust the temperature of the two end regions of the main heating body, ensuring that the temperature difference of the whole product region is small, and fundamentally improving the qualification rate of a product.

(3) According to the novel furnace door heating apparatus and the horizontal sintering furnace thereof, the concave cavities of the first main heating body, the second main heating body and the third main heating body in the main heating body all face the material bearing region, thus ensuring that the heat generated by the main heating body is uniformly distributed, that is, the product in the material bearing region is uniformly heated, and the temperature difference in the material bearing region of the product is reduced to the greatest extent.

### BRIEF DESCRIPTION OF THE DRAWINGS

FIG. 1 is a schematic diagram of a traditional furnace door heating apparatus;

FIG. 2 is a structural schematic diagram of a novel furnace door heating apparatus according to the present disclosure;

FIG. 3 is a structural schematic diagram of the novel furnace door heating apparatus according to the present disclosure;

FIG. 4 is a schematic diagram of the novel furnace door heating apparatus according to the present disclosure;

FIG. 5 is a structural schematic diagram of a main heating body according to the present disclosure;

FIG. 6 is a structural schematic diagram of an auxiliary heating body according to the present disclosure.

### LIST OF THE REFERENCE CHARACTERS

1 main heating body; 11 first heating element; 12 first electric frame; 13 electric frame connecting seat; 14 first electrode connecting hole; 15 fixing nut; 2 first main heating body; 3 second main heating body; 4 third main heating body; 5 auxiliary heating body; 51 second heating element; 52 second electric frame; 53 second electrode connecting hole; a material bearing region; and b end region.

### DETAILED DESCRIPTION OF THE EMBODIMENTS

For better understanding and implementation, the following clearly and completely describes the technical solutions in the embodiments of the present disclosure with reference to the accompanying drawings in the embodiments of the present disclosure.

In the description of the present disclosure, it needs to be understood that the orientation or positional relationship indicated by terms “upper”, “lower”, “front”, “rear”, “left”, “right”, “vertical”, “horizontal”, “top”, “bottom”, “inside” and “outside” is based on the orientation or positional relationship shown in the drawings only for convenience of description of the present disclosure and simplification of description rather than indicating or implying that the apparatus or element referred to must have a particular orientation, be constructed and operate in a particular orientation, and thus are not to be construed as limiting the present disclosure.

Unless otherwise defined, all technical and scientific terms used herein have the same meaning as commonly understood by those skilled in the art of the present disclosure. The terminology used in the description of the invention herein is only for the purpose of describing specific embodiments and is not intended to limit the present disclosure.

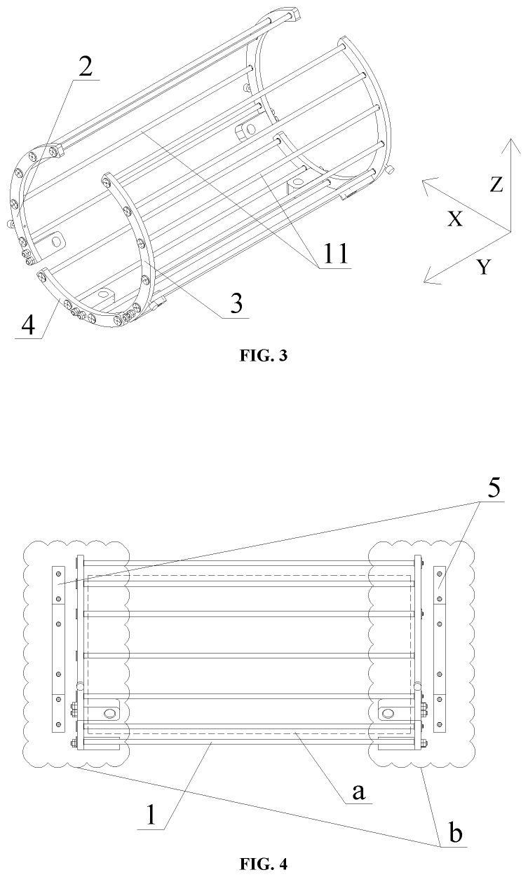

Referring to FIG. 2, FIG. 3 and FIG. 4, according to the embodiments of the present disclosure, a novel furnace door heating apparatus includes a main heating body 1 and auxiliary heating bodies 5.

The main heating body 1 includes a first main heating body 2, a second main heating body 3, and a third main heating body 4. The first main heating body 2 and the second main heating body 3 are arranged opposite to each other in an X-axis direction, and the third main heating body 4 is arranged at a bottom position of the first main heating body 2 and the second main heating body 3 in a Z-axis direction. That is, with the Y axis as the line of sight of the front view, the first main heating body 2 and the second main heating body 3 are arranged on the left and right sides, and the third main heating body 4 is arranged at the bottom position between the first main heating body 2 and the second main heating body 3. By means of such a structural design mode, the whole main heating body 1 is divided into a left heating body, a right heating body, and a lower heating body. More specifically, the first main heating body 2 and the third heating body 3 may be symmetrically arranged, thus ensuring the heating uniformity of a product region by the first main heating body 2 and the second main heating body 3.

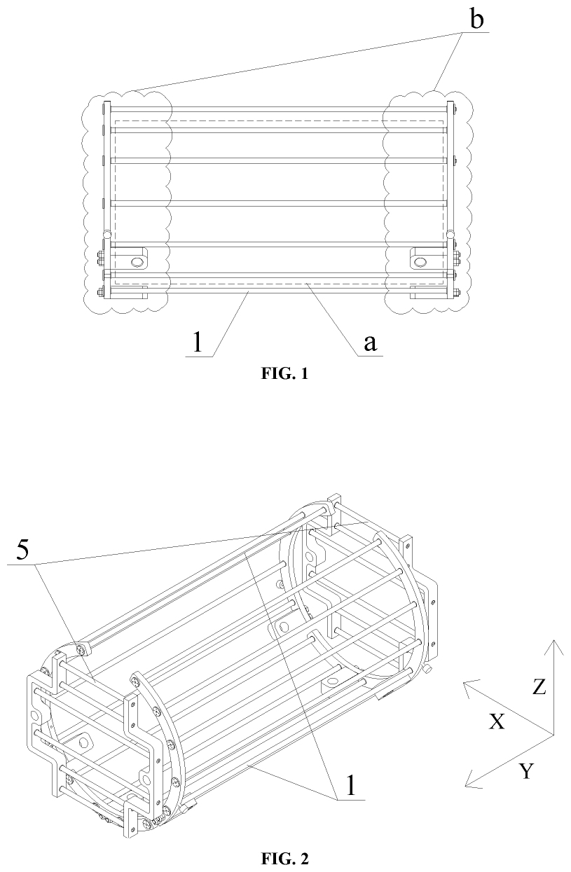

The auxiliary heating bodies 5 are arranged in two end regions of the main heating body 1 in a Y-axis direction, and both are arranged adjacent to the main heating body 1. Moreover, the two auxiliary heating bodies 5 are used to heat the two end regions of the main heating body 1 in the Y-axis direction. Referring to FIG. 1, a material bearing region a of a traditional furnace door heating apparatus is a product placing region, and products placed at two ends (that is, the end regions b) in this region will have the phenomenon of local low temperature, the main reason is that the heating apparatus is of a longitudinally extending structure, and the end regions b at two ends have no heating body, so when the power of the heating body is adjusted, the temperature at the two ends cannot follow the temperature change in the middle portion in real time, resulting in the difference of products in the same furnace. In the technical solution of this embodiment, referring to FIG. 4, the heat generated by the two newly increased auxiliary heating bodies 5 can be directly radiated to low-temperature regions (i.e., end regions b) of the two end regions of the main heating body, thus completely solving the technical problem that the temperature of two ends of the traditional heating apparatus is lower than that in the middle portion of the traditional heating apparatus, and ensuring the quality consistency of the whole product.

In the technical solution of this embodiment, a material bearing region a is formed among the first main heating body 2, the second main heating body 3 and the third main heating body 4, and the first main heating body 2, the second main heating body 3 and the third main heating body 4 are used to heat the material bearing region a. Specifically, the material bearing region a is a product placing region, which is used to generate heat during operation to uniformly heat products placed at this region.

In a parallel technical solution of this embodiment, the auxiliary heating bodies 5 are independent temperature control apparatuses, which are used for heating the two end regions of the main heating body 1 in the Y-axis direction. Specifically, when the power of the main heating body 1 is adjusted, the heating value of the material bearing region a will increase correspondingly as a whole, and the temperature of the two end regions (i.e., end regions b) of the main heating body I cannot be adjusted independently. By providing the auxiliary heating bodies 5, the temperature of the two end regions (i.e., end regions b) of the main heating body 1 can be adjusted, thus ensuring the temperature difference of the whole product region, and fundamentally improving the qualification rate of the product.

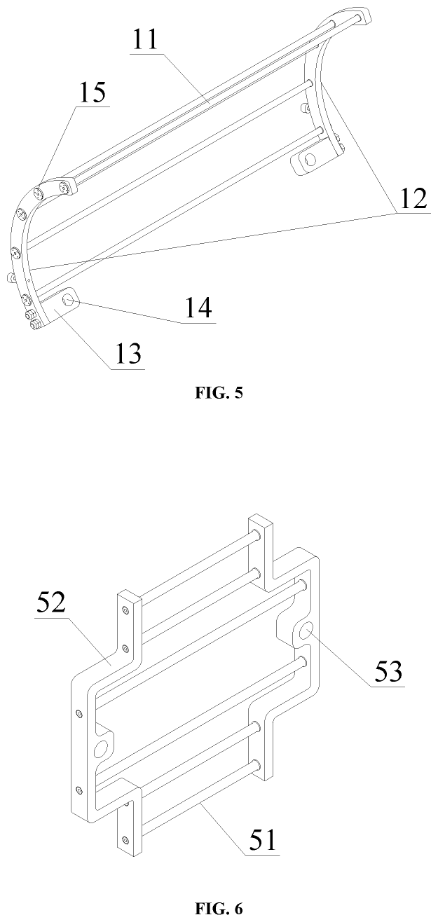

Referring to FIG. 5, in an alternative technical solution of this embodiment, the main heating body 1 includes first electric frames 12 and multiple first heating elements 11, and the first heating elements 11 are fixedly assembled between the two first electric frames 12 and extend between the two first electric frames 12 in the Y-axis direction. In this alternative technical solution, the first heating elements 11 between the two first electric frames 12 are arranged in an extending manner in the Y-axis direction, thus generating heat during operation and uniformly heating the product in the material bearing region a. More specifically, the structural design mode of extending in the Y-axis direction is more consistent with an internal structure of the horizontal sintering furnace, thereby improving the utilization rate of the internal space of the horizontal sintering furnace product.

Referring to FIG. 5, in a preferred technical solution of this embodiment, the number of the first heating elements 11 is greater than or equal to two, and the distances between adjacent first heating elements 11 are equal, making the first heating elements 11 uniformly distributed on the first electric frames 12. Specifically, by distributing the first heating elements 11 uniformly on the first electric frames 12, the heat generated by the multiple first heating elements 11 on the first electric frames 12 can be ensured to radiate uniformly into the material bearing region a, that is, the product in the material bearing region a can be heated uniformly.

As shown in FIG. 5, in another preferred technical solution of this embodiment, the first electric frame 12 is assembled with an electric frame connecting seat 13, the electric frame connecting seat 13 is provided with a first electrode connecting hole 14, and the first electrode connecting hole 14 is used for connecting an electrode. In this preferred technical solution, the first electrode connecting hole 14 on the electric frame connecting seat 13 is used for assembling and connecting an electrode inside the horizontal sintering furnace of the present disclosure, and is used for providing a conductive function for the first electric frame 12 on the main heating body 1. More specifically, the electrode may be a graphite electrode, which has the characteristics of high temperature resistance and heating resistance, and is consistent with the usage scenario of the horizontal sintering furnace of the present disclosure.

Referring to FIG. 3 and FIG. 5, in another alternative technical solution of this embodiment, the first electric frame 12 is of an arc structure, making the whole main heating body 1 show a circular arc structure with a concave cavity, and the concave cavities of the first main heating body 2, the second main heating body 3 and the third heating body 4 all face the material bearing region a. In this alternative technical solution, each of the first main heating body 2, the second main heating body 3 and the third main heating body 4 is of a circular arc structure with a concave cavity, such that the first main heating body 2, the second main heating body 3 and the third heating body 3 enclose a roughly cylindrical structure, and the inside of the cylindrical structure is the material bearing region a. More specifically, the concave cavity portion of each of the first main heating body 2, the second main heating body 2 and the third main heating body 3 faces the material bearing region a, thus utilizing the heating space and heating rate of the main heating body 1 to the greatest extent, and further improving the heating uniformity of the main heating body 1.

Referring to FIG. 5, further, the novel furnace door heating apparatus further includes a fixing nut 15. The fixing nut 15 penetrates through the first electric frame 12 and then through the first heating element 11 in the Y-axis direction, thus fixedly assembling the first heating element 11 on the first electric frame 12. In a further technical solution, when the main heating body 1 is specifically assembled, each first heating element 11 is aligned with a corresponding assembling portion corresponding to the first electric frame 12, and then the fixing nut 15 is screwed into the first electric frame 12 and the first heating element 11 in sequence in the Y-axis direction to complete the assembly of the first electric frame 12 and the first heating element 11. Similarly, when disassembling the main heating body 1, the fixing nut 15 is reversely rotated to be taken from the first electric frame 12 and the first heating element 11, thus completing the disassembly operation of the first electric frame 12 and the first heating element 11. The whole assembly and disassembly operation is simple and convenient, and the structural stability is high.

More specifically, the fixing nut 15 is the general name of connecting parts, which may be any one or more of bolts, screws, or cap screws.

Referring to FIG. 6, in another embodiment of the present disclosure, the auxiliary heating body 5 includes second electric frames 52 and multiple second heating elements 51, and the second heating elements 51 are fixedly assembled between the two second electric frames 52 and extend between the two first electric frames 52 in the X-axis direction. In the technical solution of this embodiment, the second heating elements 51 between the two second electric frames 52 are arranged in an extending manner in the X-axis direction, thus generating heat during operation and uniformly heating the product in two end regions (i.e., end regions b) of the main heating body 1. More specifically, the structural design mode of extending in the X-axis direction is more consistent with the two end regions (i.e., the end regions b) of the main heating body 1, so as to improve the heating uniformity of the material bearing region a, ensure the quality consistency of the whole product, and fundamentally improve the qualification rate of the product.

Referring to FIG. 6, in a preferred technical solution of this embodiment, the number of the second heating elements 51 is greater than or equal to two, and the distances between adjacent second heating elements 51 are equal, making the second heating elements 51 uniformly distributed on the second electric frames 52. In this preferred technical solution, by distributing the second heating elements 51 uniformly on the second electric frames 52, the heat generated by multiple second heating elements 51 on the second electric frames 52 can be ensured to radiate uniformly into the two end regions (i.e., end regions b) of the main heating body 1, i.e., the product in two end regions (i.e., end regions b) of the main heating body 1 can be heated uniformly.

As shown in FIG. 6, in another preferred technical solution of this embodiment, the second electric frame 52 is provided with a protruded portion, the protruded portion is provided with a second electrode connecting hole 53, and the second electrode connecting hole 53 is used for connecting with an electrode. In this preferred technical solution, the second electrode connecting hole 53 on the protruded portion is used for assembling and connecting with an electrode inside the horizontal sintering furnace of the present disclosure, and is used for providing a conductive function for the second electric frame 52 on the auxiliary heating body 5.

More specifically, the electrode may be a graphite electrode, which has the characteristics of high temperature resistance and heating resistance, and is consistent with the usage scenario of the horizontal sintering furnace of the present disclosure.

Based on the same design though, the present disclosure further provides an embodiment of a horizontal sintering furnace. The horizontal sintering furnace includes the novel furnace door heating apparatus of the above embodiment.

In the technical solution of this embodiment, the horizontal sintering furnace further includes a furnace door, the auxiliary heating body 5 is fixedly assembled on the furnace door by means of an electrode, such that relative positions of the two (i.e., the auxiliary heating body 5 and the furnace door) can remain unchanged when the furnace door is opened or closed. Specifically, the auxiliary heating body 5 is fixedly assembled on the furnace door, on the one hand, the space arrangement problem of the auxiliary heating body 5 can be solved, and thus there is no need to design an additional auxiliary connecting structure or auxiliary support structure for the assembly of the auxiliary heating body 5; on the other hand, by means of an assembly design mode of connecting the auxiliary heating body 5 and the furnace door, the auxiliary heating body 5 and the main heating body 1 are just corresponding to and adjacent to each other when the furnace door of the horizontal sintering furnace is closed, so as to heat the two end regions (i.e., end regions b) of the main heating body 1 uniformly. When the furnace door of the horizontal sintering furnace is opened, the auxiliary heating body 5 leaves the main heating body 1, and stops heating the end regions b.

In conclusion, according to the novel furnace door heating apparatus and a horizontal sintering furnace thereof, two end regions of the main heating body 1 in the Y-axis direction are both provided with auxiliary heating bodies 5, and the heat generated by the two newly increased auxiliary heating bodies 5 can be directly radiated to low-temperature regions of the two end regions of the main heating body 1, thus thoroughly solving the technical problem that the temperature of both ends of the traditional heating apparatus is lower than the temperature of the middle portion of the traditional heating apparatus and ensuring the quality consistency of the whole product. Moreover, the auxiliary heating body 5 is an independent temperature control apparatus, when the power of the main heating body 1 is adjusted, the heating value of the material bearing region a will increase correspondingly as a whole, and the temperature of the two end regions of the main heating body cannot be adjusted independently, but the auxiliary heating body 5 with independent temperature control function can adjust the temperature of the two end regions of the main heating body 1, thus ensuring the temperature difference of the whole product region, and fundamentally improving the qualification rate of the product. In addition, the concave cavities of the first main heating body 2, the second main heating body 3 and the third main heating body 4 in the main heating body all face the material bearing region a, thus ensuring uniform distribution of the heat generated by the main heating body 1. That is, the product in the material bearing region a is heated uniformly, and the temperature difference in the product material bearing region a is reduced to the greatest extent.

The technical means disclosed in the solution of the present disclosure are not limited to the technical means disclosed in the above embodiments, but also include the technical solution composed of any combination of the above technical features. It should be noted that, for those of ordinary skill in the art, various modifications and embellishments can be made without departing from the principle of the present disclosure. Such modifications and embellishments shall be regarded as falling into the scope of protection of the present disclosure.

1-10. (canceled)

11. A novel furnace door heating apparatus, comprising:
a main heating body, wherein the main heating body comprises a first main heating body, a second main heating body, and a third main heating body, the first main heating body and the second main heating body are arranged opposite to each other in an X-axis direction, and the third main heating body is arranged at a bottom position of the first main heating body and the second main heating body in a Z-axis direction;
auxiliary heating bodies, wherein one of the auxiliary heating bodies is arranged in one of two end regions of the main heating body in a Y-axis direction, and an other one of the auxiliary heating bodies is arranged in an other one of two end regions of the main heating body in a Y-axis direction; and the auxiliary heating bodies are arranged adjacent to the main heating body;
wherein a material bearing region is formed among the first main heating body, the second main heating body and the third main heating body, and the first main heating body, the second main heating body and the third main heating body are configured for heating the material bearing region; and
the auxiliary heating bodies are independent temperature control devices, and are configured for heating the two end regions of the main heating body in the Y-axis direction.

12. The novel furnace door heating apparatus according to claim 11, wherein the main heating body comprises first electric frames and a plurality of first heating elements, and the plurality of first heating elements are fixedly assembled between two first electric frames and extend between the two first electric frames in the Y-axis direction.

13. The novel furnace door heating apparatus according to claim 12, wherein a number of the plurality of first heating elements is greater than or equal to two, and distances between every two adjacent first heating elements of the plurality of first heating elements are equal to make the plurality of first heating elements uniformly distributed between the first electric frames.

14. The novel furnace door heating apparatus according to claim 12, wherein each of the first electric frames is assembled with an electric frame connecting seat, the electric frame connecting seat is provided with a first electrode connecting hole, and the first electrode connecting hole is configured for connecting with a first electrode.

15. The novel furnace door heating apparatus according to claim 12, wherein each of the first electric frames is of an arc structure, which enables the main heating body as a whole to form a circular arc structure with a concave cavity, and concave cavities of the first main heating body, the second main heating body and the third heating body all face the material bearing region.

16. The novel furnace door heating apparatus according to claim 12, further comprising fixing nuts, wherein the fixing nuts penetrate through the first electric frames and then through the plurality of first heating elements in the Y-axis direction to fixedly assemble the plurality of first heating elements on the first electric frames.

17. The novel furnace door heating apparatus according to claim 11, wherein each of the auxiliary heating bodies comprises second electric frames and a plurality of second heating elements, and the plurality of second heating elements are fixedly assembled between two second electric frames and extend between the two second electric frames in the X-axis direction.

18. The novel furnace door heating apparatus according to claim 17, wherein a number of the plurality of second heating elements is greater than or equal to two, and distances between every two adjacent second heating elements of the plurality of second heating elements are equal to make the plurality of second heating elements uniformly distributed between the second electric frames.

19. The novel furnace door heating apparatus according to claim 17, wherein each of the second electric frames is provided with a protruded portion, the protruded portion is provided with a second electrode connecting hole, and the second electrode connecting hole is configured for connecting a second electrode.

20. A horizontal sintering furnace comprising a novel furnace door heating apparatus, wherein the novel furnace door heating apparatus comprises:
a main heating body, wherein the main heating body comprises a first main heating body, a second main heating body, and a third main heating body, the first main heating body and the second main heating body are arranged opposite to each other in an X-axis direction, and the third main heating body is arranged at a bottom position of the first main heating body and the second main heating body in a Z-axis direction;
auxiliary heating bodies, wherein one of the auxiliary heating bodies is arranged in one of two end regions of the main heating body in a Y-axis direction, and an other one of the auxiliary heating bodies is arranged in an other one of two end regions of the main heating body in a Y-axis direction; and the auxiliary heating bodies are arranged adjacent to the main heating body;
wherein a material bearing region is formed among the first main heating body, the second main heating body and the third main heating body, and the first main heating body, the second main heating body and the third main heating body are configured for heating the material bearing region; and
the auxiliary heating bodies are independent temperature control devices, and are configured for heating the two end regions of the main heating body in the Y-axis direction;
the horizontal sintering furnace further comprising a furnace door, wherein the auxiliary heating bodies are fixedly assembled on the furnace door by means of electrodes, such that relative positions of the auxiliary heating bodies and the furnace door remain unchanged when the furnace door is opened or closed.

21. The horizontal sintering furnace according to claim 20, wherein the main heating body comprises first electric frames and a plurality of first heating elements, and the plurality of first heating elements are fixedly assembled between two first electric frames and extend between the two first electric frames in the Y-axis direction.

22. The horizontal sintering furnace according to claim 21, wherein a number of the plurality of first heating elements is greater than or equal to two, and distances between every two adjacent first heating elements of the plurality of first heating elements are equal to make the plurality of first heating elements uniformly distributed between the first electric frames.

23. The horizontal sintering furnace according to claim 21, wherein each of the first electric frames is assembled with an electric frame connecting seat, the electric frame connecting seat is provided with a first electrode connecting hole, and the first electrode connecting hole is configured for connecting with a first electrode.

24. The horizontal sintering furnace according to claim 21, wherein each of the first electric frames is of an arc structure, which enables the main heating body as a whole to form a circular arc structure with a concave cavity, and concave cavities of the first main heating body, the second main heating body and the third heating body all face the material bearing region.

25. The horizontal sintering furnace according to claim 21, wherein the fixing nuts penetrate through the first electric frames and then through the plurality of first heating elements in the Y-axis direction to fixedly assemble the plurality of first heating elements on the first electric frames.

26. The horizontal sintering furnace according to claim 20, wherein each of the auxiliary heating bodies comprises second electric frames and a plurality of second heating elements, and the plurality of second heating elements are fixedly assembled between two second electric frames and extend between the two second electric frames in the X-axis direction.

27. The horizontal sintering furnace according to claim 26, wherein a number of the plurality of second heating elements is greater than or equal to two, and distances between every two adjacent second heating elements of the plurality of second heating elements are equal to make the plurality of second heating elements uniformly distributed between the second electric frames.

28. The horizontal sintering furnace according to claim 26, wherein each of the second electric frames is provided with a protruded portion, the protruded portion is provided with a second electrode connecting hole, and the second electrode connecting hole is configured for connecting a second electrode.
